(19) United States
(12) Patent Application Publication
(10) Pub. No.: US 2015/0282103 A1
(43) Pub. Date: Oct. 1, 2015

(54) SYSTEM, METHOD, AND APPARATUS FOR CONTROLLING DUAL CONNECTIVITY UPLINK POWER

(71) Applicant: BROADCOM CORPORATION, Irvine, CA (US)

(72) Inventors: Antti Oskari IMMONEN, Helsinki (FI); Jussi Ojala, Helsinki (FI); Helka-Liina Maattanen, Helsinki (FI); Sami Jukka Hakola, Kempele (FI)

(73) Assignee: BROADCOM CORPORATION, Irvine, CA (US)

(21) Appl. No.: 14/673,245

(22) Filed: Mar. 30, 2015

Related U.S. Application Data
(60) Provisional application No. 61/971,712, filed on Mar. 28, 2014.

(51) Int. Cl. H04W 52/34; H04L 5/00; H04W 72/04

(52) U.S. Cl. CPC H04W 52/346; H04W 72/0406; H04L 5/0092

(57) ABSTRACT

A device includes circuitry configured to determine that a total transmit power of two or more pending transmissions exceeds a maximum transmit power. Power difference thresholds are determined for the two or more pending transmissions corresponding to a difference between a desired transmit power and an allowed transmit power. At least one pending transmission is identified to send based on the power difference thresholds.

### CROSS-REFERENCE TO RELATED PATENT APPLICATIONS

The present application claims the benefit of the earlier filing date of U.S. provisional application 61/971,712 having common inventorship with the present application and filed in the U.S. Patent and Trademark Office on Mar. 28, 2014, the entire contents of which being incorporated herein by reference.

### BACKGROUND

1. Technical Field

The present disclosure is related to wireless communications systems, methods, devices, and computer-implemented processes. More specifically, the disclosure relates to power scaling operations for user equipment (UE) having dual connectivity to at least two different cells or transmission reception points.

2. Description of the Related Art

In the Third Generation Partnership Project (3GPP) for Evolved UMTS Terrestrial Radio Access Network (E-UTRAN, also referred to as Long Term Evolution or LTE including LTE-Advanced), there has been interest in having dual connectivity user equipment (UE). With dual connectivity, a UE in a Radio Resource Control (RRC) Connected state can be configured to simultaneously utilize radio resources provided by independent E-UTRAN Node Bs (eNodeBs or eNBs), one characterized as a Master eNB (MeNB) and the other characterized as a Secondary eNB (SeNB), operating on different frequency carriers.

In addition, multiple serving cells can be configured for the UE associated with the MeNB and/or SeNB. A master cell group (MCG) is a group of serving cells associated with the MeNB and a secondary cell group (SCG) is a group of the serving cells associated with the SeNB. The physical layer and the medium access control (MAC) layer of the MeNB and SeNB operate independently in a dual connectivity connection of the UE. The backhaul between the MeNB and SeNB is assumed to be non-ideal, which means that coordinated scheduling decisions between the MeNB and SeNB may not be feasible due to timing considerations.

With dual connectivity transmissions, operations to control transmit power of the UE on the uplink physical channels within each cell group and across cell groups occur independently. In addition, the MeNB and SeNB schedule uplink transmissions within corresponding cell groups independent of each other, which can add complexity to handling the UE's transmission power resources as compared to conventional uplink carrier aggregation. For example, the MeNB (SeNB) does not know the scheduling and resource allocation decision for the physical uplink shared channel (PUSCH) transmissions that are performed by the SeNB (MeNB) for a given subframe due to the non-ideal backhaul. Further, the MeNB (SeNB) is unaware of the occasions of PUCCH transmissions to the SeNB (MeNB) that are to be performed by the UE.

The conventional power headroom that is calculated and reported by the UE to the serving eNB per reflects the spare power in a subframe for a scheduling and resource allocation decision made by the UE's serving eNB. The power headroom report (PHR) gives the serving eNB updated information about the UE's available power budget which the serving eNB can take into account when making its upcoming scheduling decisions. Details of such conventional power headroom reporting may be seen in Release 11 of the 3GPP standard, for example, at section 5.4.6 of 3GPP TS 36.321; section 5.1.1.2 of 3GPP TS 36.213; and section 9.1.8 of 3GPP TS 36.133. With dual connectivity, problems can arise from one serving eNB not knowing how much of the transmission power resources the UE is using in a certain subframe for a scheduling decision made by the other eNB since conventional PHRs may be separately triggered for both the MeNB and the SeNB in the dual-connected UE case. For situations where user plane data is transmitted by the UE to both the MCG and the SCG in the uplink direction, optimistic (aggressive) scheduling by the MeNB and SeNB could lead to a situation where the UE may need to perform power scaling frequently. On the other hand, pessimistic scheduling by the MeNB and SeNB could lead to under-using the available radio resources and thus not achieving the efficiency provided by dual connectivity.

The UE can determine in advance if two pending transmissions overlap in time and exceed a maximum allowed (total) transmit power for the UE. This maximum allowed transmit power can depend on the UE's power class rating. The UE can perform power scaling to reduce the transmit power on one or both of the pending uplink transmissions. However, maximizing the UE's available transmit power across both simultaneous connections can be difficult, particularly in view of conventional closed loop power control whereby the MeNB and/or the SeNB give feedback to the UE to step up or step down transmit power for the next transmission.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exemplary illustration of a dual connectivity radio environment, according to certain embodiments;

FIG. 2 is an exemplary flowchart of dual connectivity power scaling process, according to certain embodiments;

FIG. 3 is an exemplary flowchart of a process for determining a power difference threshold, according to certain embodiments;

FIG. 4 is an exemplary flowchart of a power scaling process, according to certain embodiments; and

FIG. 5 illustrates a non-limiting example of a UE, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “about,” and similar terms generally refer to ranges that include the identified value within a margin of 20%, 10%, or preferably 5%, and any values therebetween.

Aspects of this disclosure are directed to a UE operating with dual connectivity in a E-UTRAN network. The embodiments described herein are merely exemplary and are not meant to limit the scope of the disclosure. For example, the disclosure is directed to a UE having two simultaneous eNB connections, but the implementations described herein can also be applied to UEs having greater than two simultaneous connections. In addition, the embodiments described herein can also be applied to other types of wireless systems and radio access technologies, including UTRAN, LTE-Advanced (LTE-A), and High Speed Packet Access (HSPA), and the like. Embodiments of these teachings address how a dual-connected UE can most effectively use available transmit power to transmit simultaneous pending transmissions.

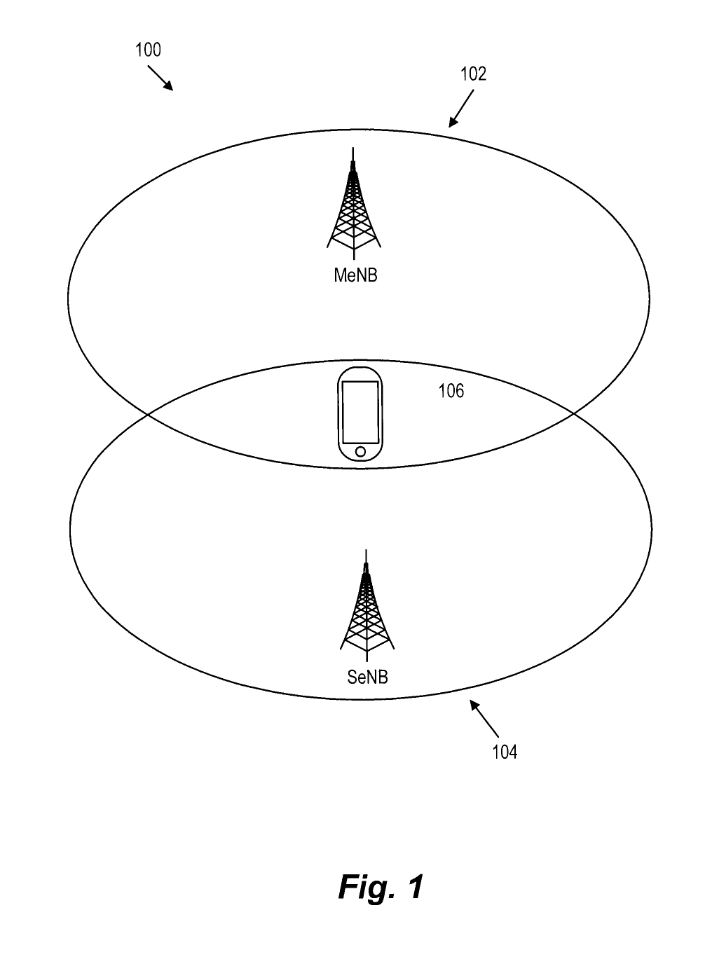

FIG. 1 is an exemplary illustration of a dual connectivity radio environment 100, according to certain embodiments. The radio environment 100 can be a heterogeneous radio environment where a UE 106 can have a RCC connection with master eNB (MeNB) 102 at a first frequency, F1, and a secondary eNB (SeNB) 104 on a second frequency, F2. In some implementations, other serving cells can be associated with the MeNB 102 and SeNB 104 that are considered to be part of a master cell group (MCG) for the MeNB 102. In addition, the SeNB 104 can also have other serving cells that are considered to be part of a secondary cell group (SCG) for the SeNB 104.

In certain embodiments, the UE 106 is a device that can include, but is not limited to personal portable digital devices having wireless communication capabilities, such as cellular and other mobile phones including smartphones, navigation devices, laptop/palmtop/tablet computers, digital cameras and music devices, Internet appliances, USB dongles and data cards. Such portable digital devices may be implemented as radio communications handsets, wearable radio communications terminals, implanted radio communications terminals, and/or combinations of these.

Dual connectivity, also referred to as dual operation, refers to the UE 106 in the RCC CONNECTED state consuming radio resources provided by at least two independent network points, such as the MeNB 102 and the SeNB 104 that can be connected to one another with a non-ideal backhaul. Non-ideal backhaul can refer to connections that may not meet the latency and throughput requirements for ideal backhaul as described by section 6.1.3 of 3GPP TR 36.932 v12.1.0. In addition, the non-ideal backhaul between the MeNB 102 and the SeNB 104 can be referred to as an Xₙ interface. The dual connection of the UE 106 may result from a single radio bearer being split amongst the MeNB 102 and the SeNB 104, which can be referred to as a bearer split. The bearer split may occur at a serving gateway, or at the MeNB 102. In certain embodiments, the SeNB 104 may be considered a small cell, operating with reduced transmit power as compared to the MeNB 102, which can be considered a macro eNB. In addition, the SeNB 104 can have a coverage area that is fully, or at least partially, enveloped by that of the MeNB 102.

In addition, multiple serving cells can be configured for the UE 106 associated with the MeNB 102 and/or SeNB 104. A master cell group (MCG) is a group of serving cells associated with the MeNB 102 and a secondary cell group (SCG) is a group of the serving cells associated with the SeNB 104. The physical layer and the medium access control (MAC) layer of the MeNB 102 and SeNB 104 can operate independently during dual connectivity operations of the UE 106.

In certain embodiments, during dual connectivity operations, the UE 106 has a maximum transmit power that includes the sum of the transmit power on independent physical uplink channels to the MeNB 102 and SeNB 104. However, the maximum transmit power for the UE 106 can be exceeded in some implementations where the MeNB 102 and SeNB 104 independently determine a transmit power for the UE 106.

For example, in one implementation, the UE 106 is configured for a maximum total transmit power of 23 dBm. In addition, the maximum transmit power, P_{cmax,c}, for the MCG is 23 dBm and the configured maximum transmit power, P_{cmax,c}, for the SCG is 20 dBm. The corresponding power headroom reports (PHRs) for the UE 106 would be 0 dB for the MCG and 3 dB for the SCG. If the UE 106 were to transmit concurrently on these two connections, total transmit power would be 24.76 dBm, which exceeds the maximum total transmit power of 23 dBm for the UE 106. In order to ensure that the maximum transmit power for the UE 106 is not exceeded, the UE 106 can apply power scaling to one or more of the pending transmissions as will be discussed further herein. In addition, since the MCG and SCG operate independently, the SCG may issue a power up command to add an additional 1 dB based on the PHR, which would result in further power scaling by the UE 106.

According to some embodiments, the UE 106 can apply too much power scaling such that the uplink (UL) power is too low to successfully send transmissions to the MeNB 102 and SeNB 104, and available power of the UE 106 may not be effectively utilized. If UL power is reduced too much for a transmission to the MeNB 102 and/or SeNB 104, the UL transmission has a higher probability of being unsuccessfully transmitted, which can result in reduced throughput and is an inefficient use of the power transmission resources of the UE 106. By performing the one or more processes discussed further herein, the UE 106 can apply power scaling to one or more pending transmissions to the MeNB 102 and SeNB 104 while ensuring that the power reduction does not result in a loss of transmission efficiency.

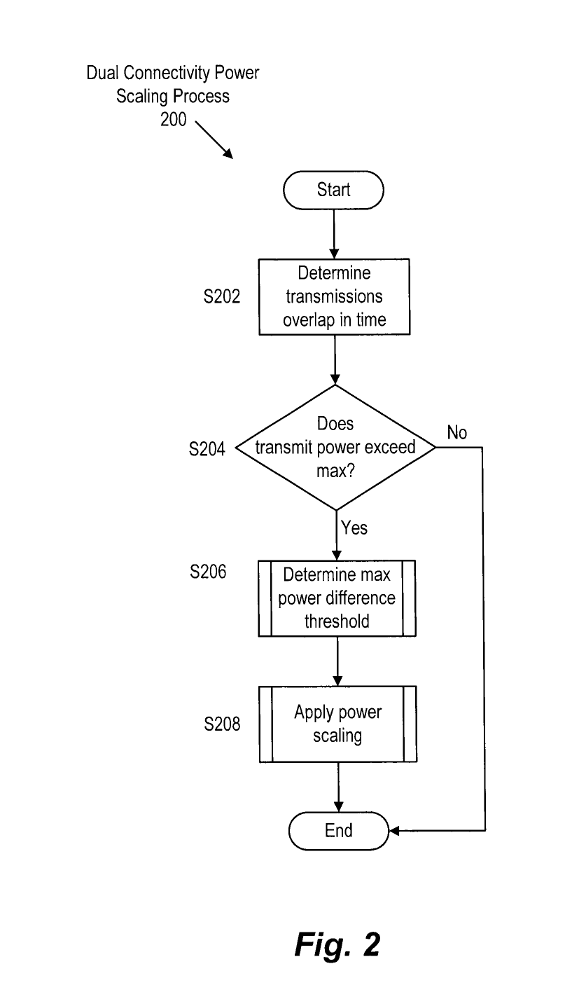

FIG. 2 is an exemplary flowchart of dual connectivity power scaling process 200, according to certain embodiments. The dual connectivity power scaling process 200 uses a power difference threshold to determine whether the power of the pending transmissions to the MeNB 102 and/or SeNB are high enough to achieve in a predetermined rate of successful transmissions. According to some implementations, the power difference threshold is equal to a difference between a desired transmit power and an allowed transmit power. The desired transmit power can be based on power commands received from the MeNB 102 and/or SeNB 104, and the allowed transmit power is based on a minimum transmit power that can achieve a predetermined error rate, such as the block error ratio (BLER). The allowed power can also be based on rates of expected successful retransmissions after an unsuccessful transmission. For example, in some networks, network power control aims to achieve a block error ratio (BLER) of 0.1 for UL transmissions. If a difference between desired transmit power and scaled transmit power is greater than the power difference threshold, it can be determined that a power scaled transmission to the MeNB 102 and/or SeNB 104 may be too low to achieve desired transmission success rates.

At step S202, the processing circuitry of the UE 106 determines that two or more pending transmissions overlap in time on two or more physical channels. For example, the processing circuitry can determine that parallel PRACH preamble transmissions are being sent to the MeNB 102 and SeNB 104. The processing circuitry can also determine that two PUCCHs transmitted on different cell groups (CGs) overlap in the time domain.

At step S204, the processing circuitry determines whether the total transmit power for the two or more transmissions exceeds a predetermined maximum transmit power for the UE 106. For example, according to one embodiment, the maximum transmit power of the UE 106 is equal to 23 dBm. If the desired power command from the MeNB 102 is 22 dBm and the desired power command from the SeNB 104 is 21 dBm, then the total transmit power is equal to 24.54 dBm, which is greater than the maximum transmit power for the UE 106. If the processing circuitry determines that the maximum transmit power for the UE 106 will be exceeded by transmitting the overlapping transmissions simultaneously, resulting in a “yes,” then step S206 is performed. Otherwise, if the processing circuitry determines that the maximum transmit power for the UE 106 will not be exceeded by transmitting the overlapping transmissions simultaneously, resulting in a “no,” then the power control process 200 is terminated and the two or more pending transmissions are transmitted to the MeNB 102 and the SeNB 104.

If it is determined at step S204 that the maximum transmit power for the UE 106 will be exceeded by sending the overlapping transmissions simultaneously, then at step S206, the processing circuitry determines a maximum power difference for the MeNB 102 and the SeNB 104, which is a maximum difference between desired power and allowed power. As will be discussed further herein, the maximum power threshold for the MeNB 102 and SeNB 104 can be determined by accessing and/or updating a stored value or by deducing a power difference threshold based on transmit power requests from the MeNB 102 and SeNB 104.

At step S208, the processing circuitry of the UE 106 applies power scaling to the one or more pending transmissions so that the maximum transmit power is not exceeded. In some implementations, the power scaling can be applied based on how the pending transmissions are prioritized. For example, transmissions to the MeNB 102 may be prioritized over transmissions to the SeNB 104 or transmissions to the MeNB 102 and SeNB may be assigned equal priority. In addition, if the power scaling of the one or more pending transmissions results in the power difference threshold being exceeded, then the UE 106 can skip and/or delay sending the associated pending transmission since the transmit power may be too low to achieve a successful transmission. Details regarding the power scaling of the one or more pending transmissions are discussed further herein.

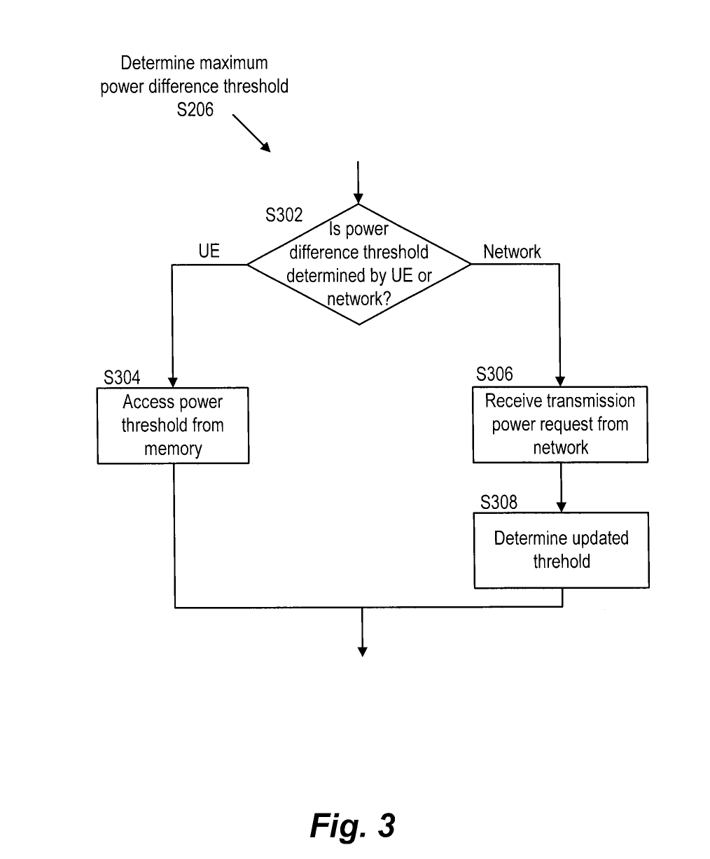

FIG. 3 is an exemplary flowchart of a process for determining the power difference threshold of step S206, according to certain embodiments. In some implementations, a first power difference threshold is associated with transmissions to the MeNB 102, and a second power difference threshold is associated with transmissions to the SeNB 104. At step S302, the processing circuitry of the UE 106 determines whether the power difference threshold for the MeNB 102 and SeNB 104 is network-determined or UE-determined. If the power difference threshold is UE-determined, then step S304 is performed. Otherwise, if the power difference threshold is network-determined, then step S304 is performed. For example, the power difference threshold is network-determined if UE 106 receives the power difference threshold from via a wireless downlink transmission from the MeNB 102 and/or SeNB 104.

At step S304, if the power difference threshold is UE-determined, the processing circuitry of the UE 106 accesses the value of the power difference threshold for the transmissions to the MeNB 102 and/or SeNB 104 from memory. In some implementations, processing circuitry of the UE 106 determines the power difference threshold by executing one or more stored processes. For example, the processing circuitry may determine the power difference threshold based on a change of location of the UE 106 and power difference thresholds from previous transmissions. If the location of the UE 106 has not changed since the previous transmission, the processing circuitry can determine that distance between the MeNB 102 and/or SeNB 104 has not changed and that a transmission power per one resource block (RB) to the MeNB 102 and/or SeNB 104 remains equal to the transmission power per one RB from the previous transmission.

At step S306, if the power difference threshold is network-determined, the UE 106 receives the power difference threshold from the MeNB 102 and/or SeNB 104 and applies the power difference thresholds to the power scaling process of step S208, as will be discussed further herein. For example, according to certain embodiments, the MeNB 102 and SeNB 104 have power difference thresholds of 3 dB. In addition, transmissions sent to the MeNB 102 and SeNB 104 can also send updates to the power difference thresholds so that retransmissions of previously skipped transmissions can be successfully transmitted.

At step S308, the processing circuitry of the UE 106 uses the power difference thresholds received from the MeNB 102 and SeNB 104 to update the power difference threshold values stored locally in the memory of the UE 106. For example, the MeNB 102 and/or SeNB 104 may allocate all RB's with a power command for a first transmission and then allocates half (50%) of the RB's with an equal power command for a subsequent transmission, resulting in a 3 dB reduction in transmit power from the UE 106. Based on the reduction in transmit power allocated by the MeNB 102 and/or SeNB 104, the processing circuitry of the UE 106 may determine that the power difference threshold may be equal to at least 3 dB.

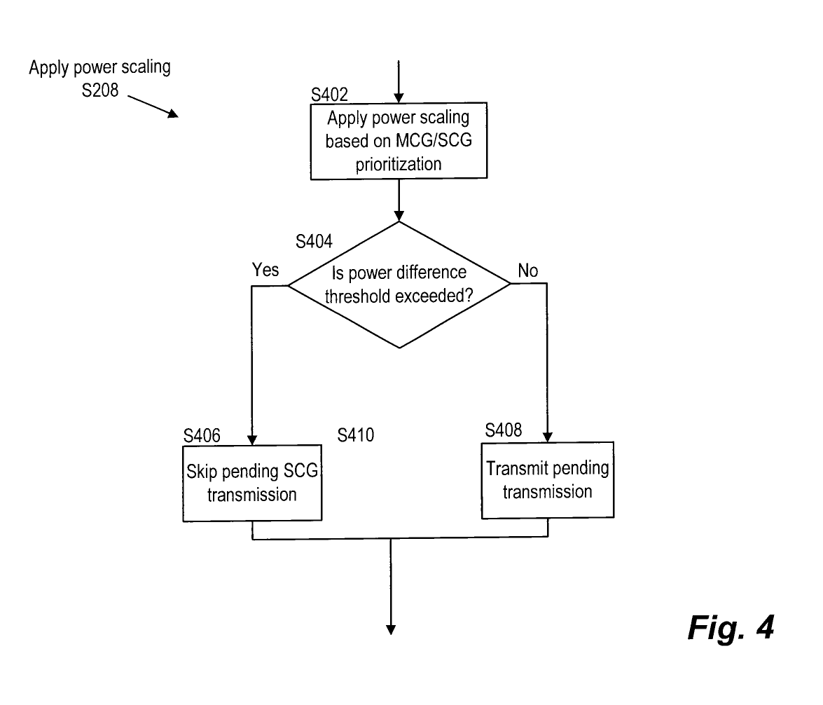

FIG. 4 is an exemplary flowchart of the power scaling process of step S208, according to certain embodiments. In some implementations, when power scaling is applied to one or more pending transmission, the difference between the desired output power and the transmit power after power scaling is greater than the power difference threshold. If the power difference threshold is exceeded, the UE 106 skips and/or delays sending the pending transmission to the SCG and/or MCG. When a transmission is skipped, the UE 106 may not need to apply power scaling to the other pending transmission if the total transmit power is less than or equal to the maximum transmit power for the UE 106.

At step S402, the processing circuitry of the UE 106 applies power scaling to the one or more pending transmissions signals based on MCG and/or SCG prioritization. One or more types of prioritization can be applied to the pending uplink transmissions to the MCG and SCG to determine whether to apply power scaling to one or both of the pending transmissions. In one implementation, if transmissions to the MCG are prioritized over transmissions to the SCG, power scaling is applied to the SCG transmission so that the total transmit power for the UE 106 is less than or equal to the maximum transmit power. In the example where the power command from the MeNB 102 is 22 dBm and the power command from the SeNB 104 is 21 dBm, then the SCG transmit power is scaled to 16.1 dBm, which results in a total transmit power of 23 dBm, which is equal to the maximum transmit power for the UE 106.

In another embodiment, if MCG and SCG transmissions are equally prioritized, power scaling is equally applied to the MCG and SCG transmissions. For example, if the power command from the MeNB 102 is 22 dBm and the power command from the SeNB 104 is 21 dBm, then the scaled MCG transmit power would be equal to 20.46 dBm, and the scaled SCG transmit power would be equal to 19.46 dBm, which results in a total transmit power of 23 dBm, which is equal to the maximum transmit power for the UE 106.

At steps S404, the processing circuitry determines whether the power difference threshold has been exceeded for the one or more power scaled transmissions. According to one implementation, the power difference threshold for the MCG and SCG is equal to 3 dB. In the example where the MCG is prioritized higher than the SCG and the SCG transmit power is scaled to 16.1 dBm, the difference between the desired transmit power of 21 dBm and the scaled transmit power of 16.1 dBm is equal to 4.9 dB, which exceeds the power difference threshold of 3 dBm. In the example where the MCG and SCG are equally prioritized, the MCG transmit power is scaled to 20.46 dBm, and the SCG transmit power is scaled to 19.46 dBm. The difference between the desired transmit power of 21 dBm for the SCG and the scaled transmit power of 19.46 dBm is equal to 1.54 dB, which is less than the power difference threshold of 3 dBm. In addition, the difference between the desired transmit power of 23 dBm for the MCG and the scaled transmit power of 20.46 dBm is equal to 1.54 dB, which is also less than the power difference threshold of 3 dB.

If the difference between the desired transmit power and the scaled transmit power is greater than the power difference threshold, resulting in a “yes,” then step S406 is performed. Otherwise, if the difference between the desired transmit power and the scaled transmit power is less than or equal to the power difference threshold, resulting in a “no,” then step S408 is performed.

At step S406, the UE 106 skips the pending transmission if the difference between the desired transmit power and the scaled transmit power is greater than the power difference threshold. By skipping one or more pending transmissions when the power difference threshold is exceeded, overall throughput is increased and BLER is decreased for the uplink transmission that is not skipped. In an exemplary implementation, both a first pending transmission and a second pending transmission are power scaled. If the processing circuitry determines that the first pending transmission is to be sent and the second pending transmission is to be skipped, then the first pending transmission may be sent at the desired transmit power without power scaling.

At step S408, the UE 106 transmits the pending power scaled transmissions if the difference between the desired transmit power and the scaled transmit power is less than or equal to the power difference threshold. For the example of the equally prioritized MCG and SCG transmissions described previously, the difference between the desired transmit power and the scaled transmit power was less than the power difference threshold of 3 dB for both the MCG and SCG transmissions so neither the MCG transmission nor the SCG transmission is skipped.

Embodiments of these teachings address transmission power scaling operations, which can support combinations of uplink physical channels transmitted in parallel in dual connectivity. Properly implemented power scaling can ensure that the UE 106 does not exceed the total allowed transmit maximum power by scaling down the transmission power of one or more of the different physical channels on which the UE 106 is sending overlapping uplink transmissions. In addition, the embodiments of these teachings also provide for successful uplink transmissions by ensuring that the difference between the desired power and scaled power is less than the power difference threshold.

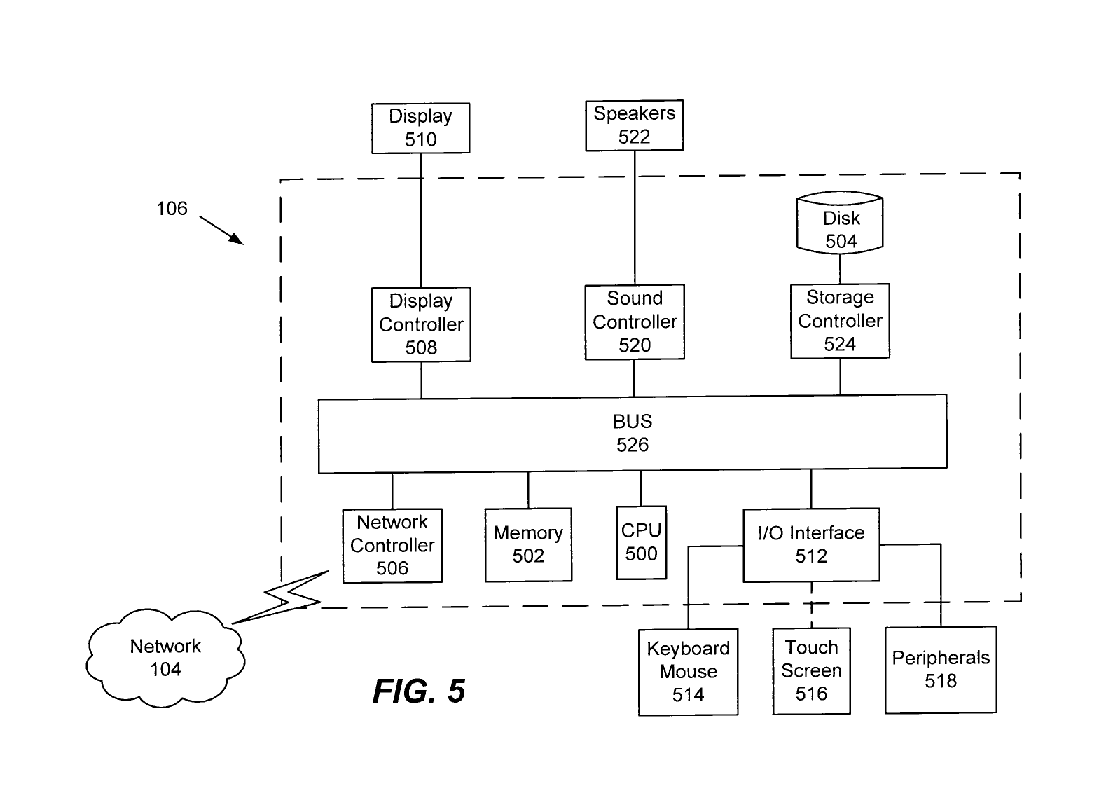

A hardware description of the UE 106 according to exemplary embodiments is described with reference to FIG. 5. In addition, the hardware described by FIG. 5 can also apply to the circuitry associated with the MeNB 102, the SeNB 104, and higher level network entities associated with the MAC (L2) and network layer (L3). The UE 106 includes a CPU 500 configured to perform the processes described above/below. The process data and instructions may be stored in memory 502. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the UE 106 communicates, such as the MeNB 102 and/or the SeNB 104.

Further, the claimed advancements may be provided as a utility application, background daemon, or component of an operating system, or combination thereof, executing in conjunction with CPU 500 and an operating system such as Microsoft Windows 7, UNIX, Solaris, LINUX, Apple MAC-OS and other systems known to those skilled in the art.

The hardware elements in order to achieve the UE 106 may be realized by various circuitry elements, known to those skilled in the art. For example, CPU 500 may be a Xenon or Core processor from Intel of America or an Opteron processor from AMD of America, or may be other processor types that would be recognized by one of ordinary skill in the art. Alternatively, the CPU 500 may be implemented on an FPGA, ASIC, PLD or using discrete logic circuits, as one of ordinary skill in the art would recognize. Further, CPU 500 may be implemented as multiple processors cooperatively working in parallel to perform the instructions of the inventive processes described above.

The UE 106 in FIG. 5 also includes a network controller 506, such as an Intel Ethernet PRO network interface card from Intel Corporation of America, for interfacing with network 104. As can be appreciated, the network 104 can be any E-UTRAN/LTE network but can also be a public network, such as the Internet, or a private network such as an LAN or WAN network, or any combination thereof and can also include PSTN or ISDN sub-networks. The network 104 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

In addition, while not particularly illustrated for the UE 106, MeNB 102, and SeNB 104, these devices can include a modem and/or a chipset and/or an antenna chip which may or may not be inbuilt onto a radiofrequency (RF) front end module within the respective host device.

The UE 106 further includes a display controller 508, such as a NVIDIA GeForce GTX or Quadro graphics adaptor from NVIDIA Corporation of America for interfacing with display 510 of the UE, such as a Hewlett Packard HPL2445w LCD monitor. A general purpose I/O interface 512 at the UE 106 interfaces with a keyboard and/or mouse 514 as well as a touch screen panel 516 on or separate from display 510. General purpose I/O interface 512 also connects to a variety of peripherals 718 including printers and scanners, such as an OfficeJet or DeskJet from Hewlett Packard.

A sound controller 520 is also provided in the UE 106, such as Sound Blaster X-Fi Titanium from Creative, to interface with speakers/microphone 522 thereby providing sounds and/or music.

The general purpose storage controller 524 connects the storage medium disk 704 with communication bus 526, which may be an ISA, EISA, VESA, PCI, or similar, for interconnecting all of the components of the UE 106. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

In other alternate embodiments, processing features according to the present disclosure may be implemented and commercialized as hardware, a software solution, or a combination thereof. Moreover, instructions corresponding to the power control process 200 in accordance with the present disclosure could be stored in a thumb drive that hosts a secure process.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, an implementation may be performed on modules or hardware not identical to those described. Accordingly, other implementations are within the scope that may be claimed.

1. A device comprising:
circuitry configured to
determine that a total transmit power of a plurality of pending transmissions exceeds a maximum transmit power;
determine power difference thresholds for the plurality of transmissions corresponding to a difference between a desired transmit power and an allowed transmit power; and
identify at least one pending transmission to send based on the power difference thresholds.

2. The device of claim 1, wherein
the circuitry is configured to determine that the plurality of pending transmission overlap in time.

3. The device of claim 1, wherein
the circuitry is configured to apply power scaling to at least of the pending transmissions so that a total transmission power of the pending transmissions is less than or equal to the maximum transmit power.

4. The device of claim 1, wherein
a first pending transmission is to a master Evolved Universal Terrestrial Access Network (E-UTRAN) Node B (eNB) and a second pending transmission is to a secondary eNB.

5. The device of claim 4, wherein
the first pending transmission is to a master cell group associated with the master eNB and the second pending transmission is to a secondary cell group associated with the secondary eNB.

6. The device of claim 4, wherein
the circuitry is configured to assign a higher priority to the first pending transmission to the master eNB than to the second pending transmission to the secondary eNB.

7. The device of claim 6, wherein
the circuitry is configured to apply power scaling to the second pending transmission when the total transmit power of the first pending transmission and the second pending transmission exceeds the maximum transmit power.

8. The device of claim 4, wherein
the circuitry is configured to assign equal priority to the first pending transmission and the second transmission.

9. The device of claim 8, wherein
the circuitry is configured to apply power scaling to the first pending transmission and the second pending transmission when the total transmit power of the first pending transmission and the second pending transmission exceeds the maximum transmit power.

10. The device of claim 4, wherein
a first power difference threshold is associated with the first pending transmission and a second power difference threshold is associated with the second pending transmission.

11. The device of claim 10, wherein
the circuitry is configured to delay sending at least one of the first pending transmission or the second pending transmission when a difference between the desired transmit power and a scaled transmit power is greater than the first power difference threshold and the second power difference threshold.

12. The device of claim 11, wherein the circuitry is further configured to:
send the first pending transmission without power scaling when the second pending transmission is delayed; and
send the second pending transmission without power scaling when the first pending transmission is delayed.

13. The device of claim 1, wherein
the circuitry is configured to determine the power difference thresholds to achieve a predetermined maximum error rate.

14. The device of claim 1, wherein
the circuitry is configured to determine the power difference thresholds based on stored values.

15. The device of claim 14, wherein
the circuitry is configured to update the power difference thresholds based on at least one of a change in location of the device or the power difference thresholds determined for one or more previous transmissions.

16. The device of claim 15, wherein
the circuitry is configured to update the power difference thresholds based on power commands received from at least one of a master eNB or a secondary eNB.

17. The device of claim 1, wherein
the circuitry is configured to receive the power difference thresholds from at least one of a master eNB or a secondary eNB.

18. The device of claim 1, wherein
the plurality of pending transmissions include physical channel uplink transmissions.

19. A method comprising:
determining that a mobile station has a first pending transmission on a first connection that overlaps in time with a second pending transmission on a second connection; and
selecting between sending both the first and second pending transmissions or sending only one of the first and second pending transmissions based on a threshold value representing a maximum difference between desired transmit power and allowed transmit power.

20. An electronic device comprising:
a memory configured to store a threshold value representing a maximum difference between desired transmit power and allowed transmit power; and
circuitry configured to
determine that the electronic device has a first pending transmission on a first connection that overlaps in time with a second pending transmission on a second connection; and
select between sending both the first and second pending transmissions or sending only one of the first and second pending transmissions based on the stored threshold value.
